(19) United States
(12) Patent Application Publication
(10) Pub. No.: US 2026/0358592 A1
(43) Pub. Date: Nov. 12, 2026

(54) Optical Lens

(71) Applicant: Genius Electronic Optical (Xiamen) Co., Ltd., Xiamen (CN)

(72) Inventors: Guangwei Fu, Xiamen (CN); Haibin Zhan, Xiamen (CN); Weiwei Fu, Xiamen (CN); Yanxiao Wang, Xiamen (CN)

(73) Assignee: Genius Electronic Optical (Xiamen) Co., Ltd., Xiamen (CN)

(21) Appl. No.: 19/245,416

(22) Filed: Jun. 23, 2025

(30) Foreign Application Priority Data
May 9, 2025 (CN) 202510596628.0

(51) Int. Cl. G02B 7/02; G02B 7/00; G03B 17/12

(52) U.S. Cl. CPC G02B 7/02; G02B 7/003; G03B 17/12

(57) ABSTRACT

The present invention provides an optical lens with its outer side chamfered in four different directions, resulting in a chamfered circular shape, which reduces the overall volume of the optical lens. Additionally, when forming the optical lens through injection molding, gaps may exist due to incomplete mold sealing, potentially causing burrs (small protruding structures) at the lens edges or uneven edge thickness due to process errors during material filling. To solve these issues, the assembly portion of the optical lens in this invention includes a plurality of protruding positioning units, symmetrically arranged at intervals. The protruding positioning units help mitigate the effects of burrs and uneven edge thickness, improving the yield and quality of lens assembly.

### BACKGROUND OF THE INVENTION

### 1. Field of the Invention

The present invention relates to the field of optics, and more particularly to an improved optical lens, wherein an assembly portion of the optical lens includes a plurality of protruding positioning units. The protruding positioning units can reduce thickness variations at the edges of the optical lens and mitigate the impact of burrs formed around the lens during molding, thereby improving the yield of optical lens assembly.

### 2. Description of the Prior Art

The specifications of portable electronic products are constantly evolving, and their key component, the optical imaging lens, is also developing in more diverse ways. The applications of optical imaging lenses are not limited to capturing images and videos but also include the demand for telephoto imaging. Combined with wide-angle optical lenses, optical zoom functionality can be achieved. Telephoto imaging optical lenses typically include optical folding elements to fold the optical path, extending the effective focal length of the lens and increasing the optical zoom magnification.

However, as the size of portable electronic products continues to shrink, the radial dimensions of optical lenses are constrained, leading to unstable assembly, which negatively impacts optical quality and product reliability. Therefore, designing a robust alignment structure to improve assembly yield under radial size constraints is a technical challenge that needs to be addressed in this field.

### SUMMARY OF THE INVENTION

The present invention provides an optical lens comprising the following features: the optical lens has a first surface facing a first side and a second surface facing a second side, an optical axis passes through the optical lens, and a radial direction perpendicular to the optical axis is defined. The optical lens further includes an optical portion through which imaging rays can pass and an assembly portion extending radially outward from an optical boundary. The optical lens satisfies the condition: 4.8%≤(ODmin−optODmin)/ODmax×100%≤19.0%, where ODmin is a minimum diameter of the optical lens, ODmax is a maximum diameter of the optical lens, and optODmin is a minimum diameter of the optical boundary. A gate cutting portion is provided, and the assembly portion closest to the gate cutting portion is defined as a reference surface. The assembly portion further includes a plurality of protruding positioning units protruding relative to the reference surface. The protruding positioning units are disposed on both sides of the gate cutting portion, each of the protruding positioning units is symmetrically arranged and spaced apart, the protruding positioning units do not contact each other, and each of the protruding positioning units does not contact the gate cutting portion. The optical imaging lens satisfies the condition: 1.40≤(ODmax−optODmax)/(ArcOD−ArcID)≤1.80, where optODmax is a maximum diameter of the optical boundary, ArcOD is an outer diameter of the protruding positioning units, and ArcID is an inner diameter of the protruding positioning units. The optical imaging lens further satisfies the condition: 0.95≤(π×ArcID×(Arcθ/360°))/(ArcOD−ArcID)≤6.00, wherein the protruding positioning units have two long sides and two short sides, the two long sides being located between the two short sides, and Arcθ is an angle formed on the reference surface between lines connecting a center point on the optical axis to the two short sides of any of the protruding positioning units.

The feature of the present invention lies in that, to increase the telephoto magnification of an optical imaging lens, it is necessary to increase the entrance pupil diameter of the optical imaging lens. However, since the entrance pupil diameter is proportional to the area of the first lens element of the optical imaging lens, this leads to an increase in the inner and outer diameter dimensions of the optical imaging lens, resulting in an increased volume of the lens barrel, which is disadvantageous for the miniaturization of optical products. Therefore, the present invention improves the structure of the optical lens by chamfering the outer side of the optical lens in four different directions, transforming the originally cylinder-shaped sidewalls of the optical lens into a symmetrical and staggered arrangement of arc wall portions and vertical wall portions. This reduces the overall volume of the optical lens. Additionally, when forming the optical lens through injection molding, gaps may exist due to incomplete mold sealing, potentially causing burrs (small protruding structures) at the lens edges or uneven edge thickness due to process errors during material filling. To solve these issues, the assembly portion of the optical lens in this invention forms a plurality of protruding positioning units, the protruding positioning units being symmetrically arranged at intervals. The protruding positioning units help mitigate the effects of the aforementioned burrs and uneven edge thickness, improving the yield and quality of lens assembly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective schematic view of an optical lens of the present invention, wherein the optical lens includes a plurality of protruding positioning units.

FIG. 2 illustrates a cross-sectional schematic view of a mold for forming the optical lens.

FIG. 3 illustrates a top view schematic diagram of an optical lens in an XY plane according to a first embodiment of the present invention.

FIG. 4 illustrates a top view schematic diagram of an optical lens in an XY plane according to a second embodiment of the present invention.

FIG. 5 illustrates a top view schematic diagram of an optical lens in an XY plane according to an eighth embodiment of the present invention.

FIG. 6 illustrates a cross-sectional schematic view of a structure of an optical lens according to an embodiment of the present invention.

FIG. 7 illustrates a partial enlarged perspective schematic view of the optical lens of the present invention.

FIG. 8 illustrates a perspective schematic view of an optical lens and a spacer of the present invention.

### DETAILED DESCRIPTION

To enable those skilled in the art to further understand the present invention, preferred embodiments of the present invention are specifically listed below, and in conjunction with the accompanying drawings, the structure and intended effects of the present invention are described in detail.

For convenience of explanation, the drawings of the present invention are merely schematic to facilitate understanding of the present invention, and their detailed proportions may be adjusted according to design requirements. The relative positional relationships of components in the drawings described herein should be understood by those skilled in the art as referring to the relative positions of objects, and thus may be flipped to present the same components, all of which should fall within the scope of the present disclosure, as stated herein.

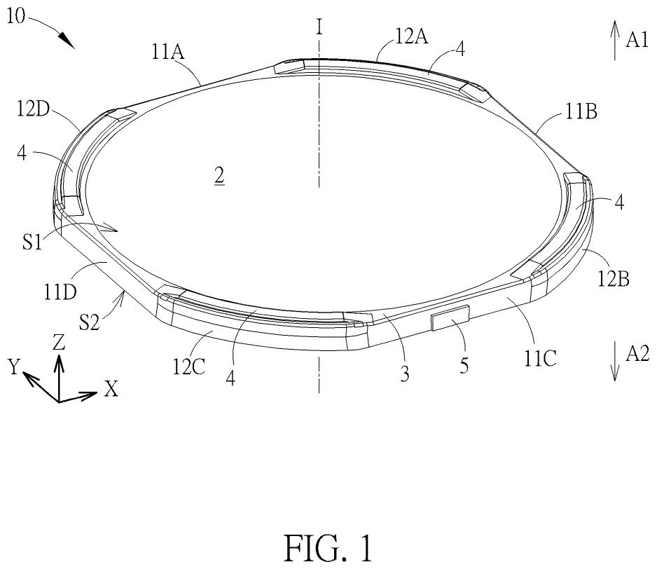

FIG. 1 illustrates a perspective schematic view of an optical lens in an optical imaging lens of the present invention. The term “optical imaging lens” as used herein refers to a lens assembly comprising a lens barrel, a retaining ring, a spacer, lens assembly with a plurality of optical lenses, and other components, used in various electronic products to provide functions such as photography and video recording. Please refer to FIG. 1, where the “optical lens 10” shown in FIG. 1 may be one of the optical lenses in an optical imaging lens. Since the following paragraphs of the present invention will focus on describing the structural features of the optical lens, the remaining parts of the optical imaging lens (e.g., lens barrel, retaining ring, etc.) are omitted and not shown, but those skilled in the art should be able to understand the positions of the lens barrel and other components by reading this document. In FIG. 1, an optical axis I, a first side A1, and a second side A2 are defined. The optical axis I is the optical axis of the entire optical imaging lens. The first side A1 is, for example, an object side of the optical imaging lens, and the second side A2 is, for example, an image side of the optical imaging lens. When rays (not shown) emitted from an object to be photographed (not shown) located on the first side A1 enters the optical imaging lens of the present invention, the light sequentially passes through each optical lens of the lens assembly along the optical axis I and focuses on an imaging plane (not shown) on the second side A2 to form a clear image.

Additionally, the aforementioned lens assembly may include a plurality of optical lenses arranged along the direction of the optical axis I (Z-axis direction), wherein parameters such as the number, size, and surface shape of the optical lenses included in the lens assembly can be adjusted according to different product requirements, and the present invention is not limited thereto. In other words, the structure of the optical lens 10 shown in FIG. 1 is merely one example of the present invention, and optical lenses with different parameters such as size and thickness can be designed according to different requirements. If an optical lens satisfies the conditions described in the following paragraphs, the optical lens falls within the scope of the present invention.

With the increasing demand for telephoto imaging in optical imaging lens, to increase the telephoto magnification of the optical imaging lens, it is necessary to increase the entrance pupil diameter of the optical imaging lens. However, since the entrance pupil diameter is proportional to the area of the optical lens 10 (in the XY plane) of the optical imaging lens, it is necessary to manufacture an optical lens with a larger area to increase the entrance pupil diameter. However, this also increases the volume of the lens barrel, which is disadvantageous for the miniaturization of optical products.

Therefore, to increase the telephoto magnification of the optical imaging lens while avoiding an excessive increase in the volume of the optical imaging lens, the present invention improves the structure of the lens barrel and the optical lens 10 of the optical imaging lens. More specifically, in conventional technology, when viewed from a top view direction (XY plane), the outer contour shape of the optical lens 10 is typically circular, and to accommodate the shape of the optical lenses, the lens barrel used to house the optical lenses also has a circular outer contour, meaning the lens barrel is cylindrical with arc-shaped sidewalls. As shown in FIG. 1, in this embodiment, the outer contour of the optical lens 10 is not circular but is composed of a shape with four straight lines and four arc lines alternating. For example, in FIG. 1, the outer sidewall of the optical lens 10 includes four vertical wall portions 11A, 111B, 11C, and 11D, and four arc wall portions 12A, 12B, 12C, and 12D, wherein the four vertical wall portions 11A, 11B, 11C, and 11D and the four arc wall portions 12A, 12B, 12C, and 12D are spaced apart and symmetrically arranged. In other words, from a top view (which can be referenced in subsequent figures), each vertical wall portion appears as a straight line, and each arc wall portion appears as an arc line. In a clockwise direction, the optical lens 10 sequentially includes the vertical wall portion 11A, the arc wall portion 12A, the vertical wall portion 11B, the arc wall portion 12B, the vertical wall portion 11C, the arc wall portion 12C, the vertical wall portion 11D, and the arc wall portion 12D. Each vertical wall portion is structurally symmetrical to another vertical wall portion in the opposite direction, and each arc wall portion is structurally symmetrical to another arc wall portion in the opposite direction. For example, the vertical wall portion 11A is symmetrical to the vertical wall portion 11C, the arc wall portion 12B is symmetrical to the arc wall portion 12D, and so forth for the other portions.

From the perspective view shown in FIG. 1, the shape of the optical lens 10 of the present invention resembles a cylinder-shaped lens that has been chamfered in four different directions, thereby reducing the area of the optical lens 10 in the XY plane. For the optical imaging lens, a lens barrel with smaller dimensions can be designed to accommodate the optical lens 10, thus reducing the outer diameter of the lens barrel and the overall volume of the optical imaging lens. For brevity, in the following paragraphs, the outer contour shape of the optical lens 10 shown in FIG. 1 is defined as a “chamfered circular shape,” which is a shape composed of four arc edges and four straight lines alternately arranged symmetrically.

It is worth noting that the present invention modifies the structure of the optical lens 10 and the lens barrel (not shown), changing the outer contour from a circular shape to a chamfered circular shape, which reduces the outer contour size of the optical lens 10 and the overall volume of the optical imaging lens. However, because the outer contour of the optical lens 10 and the lens barrel is changed to a chamfered circular shape, compared to conventional technology (e.g., where both the optical lens and the lens barrel have circular outer contours), the rotational symmetry of the outer contour of the optical lens 10 and the lens barrel is reduced. The term “rotational symmetry” as used herein refers to the property of a shape remaining identical to its original pattern after rotation. For example, a circle remains identical regardless of the angle of rotation, thus possessing infinite-order rotational symmetry, whereas a chamfered circular shape is identical to its original pattern only when rotated by 90°, 180°, 270°, or 360°, thus possessing fourth-order rotational symmetry.

When the rotational symmetry of a pattern is reduced, the alignment requirements between the optical lens 10 and the lens barrel during the assembly of the optical imaging lens are correspondingly increased. In other words, if an angular misalignment occurs between the optical lens 10 and the lens barrel during assembly, it may lead to deviations in the assembly of the optical imaging lens, potentially affecting the imaging quality of the optical imaging lens.

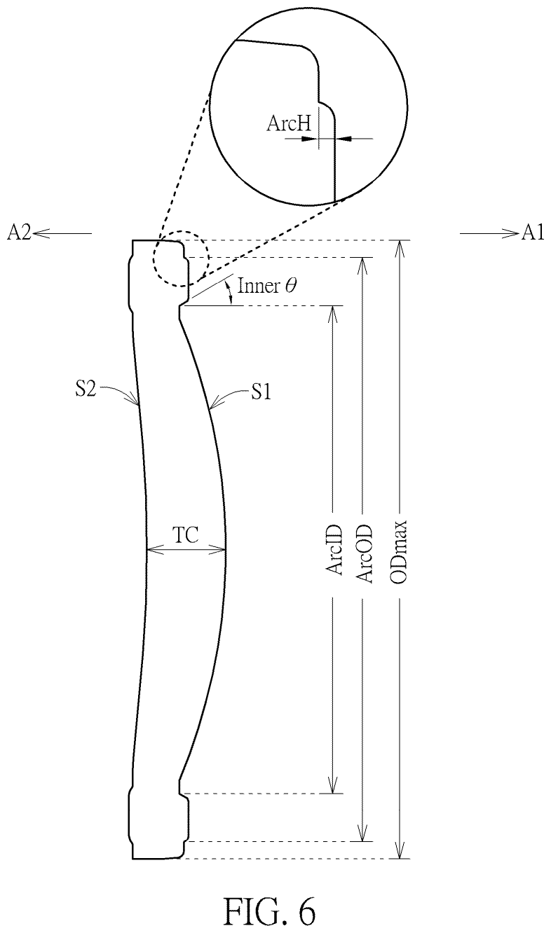

As shown in FIG. 1, the optical lens 10 of the present invention has an optical portion 2 and an assembly portion 3 located at the periphery of the optical portion 2 and extending outward in a radial direction. The optical portion 2 is the part of the optical lens 10 through which effective light primarily passes, and the assembly portion 3 is used to fix the optical lens 10 to the lens barrel. The term “radial direction” as used in the present invention refers to a direction radiating outward from the optical axis I as the axis and perpendicular to the optical axis I. In a perspective view, the radial direction includes an infinite number of directions (directions parallel to the XY plane), but in a cross-sectional view (e.g., FIG. 6 mentioned later), the optical axis I extends along the Z-direction, and the radial direction is perpendicular to the Z-axis, meaning the radial direction is parallel to the Y-axis.

To solve the potential problem of rotational misalignment between the optical lens 10 and the lens barrel, the optical lens 10 in the present invention includes a plurality of protruding positioning units 4, wherein the protruding positioning units 4 are located on the assembly portion 3, and each of the protruding positioning units 4 is symmetrically arranged and spaced apart. In other words, from a top view, the protruding positioning units 4 are not connected to each other and do not form a complete ring but rather form a plurality of separate arc-shaped structures. In this embodiment, the protruding positioning units 4 are symmetrically arranged, meaning that, along a symmetry axis passing through a center point of the optical lens 10, the protruding positioning units 4 are arranged in a mirrored manner along the symmetry axis. Additionally, from a cross-sectional view, the protruding positioning units 4, for example, have a trapezoidal shape (refer to the cross-sectional structure diagram mentioned later), but not limited thereto.

Additionally, the optical lens 10 in FIG. 1 also includes a gate cutting portion 5, wherein the gate cutting portion 5 is a cut-off surface formed during the injection molding process of the optical lens 10. In different embodiments, the optical lens 10 may include one or more gate cutting portions 5, and the present invention is not limited thereto.

To more clearly define the structural features of the present invention, in the following paragraphs, a surface of the assembly portion on the side where the protruding positioning units 4 are located (a surface parallel to the XY plane) is defined as a “reference surface.” As shown in FIG. 1, the surface of the optical lens 10 facing the first side A1 is defined as an object-side surface S1, and the surface facing the second side A2 is defined as an image-side surface S2 (the image-side surface S2 is not shown in FIG. 1; please refer to the cross-sectional view in FIG. 6). As seen in FIG. 1, the protruding positioning units 4 are formed on the object-side surface S1 of the optical lens 10, so for the protruding positioning units 4, the reference surface is the surface of the assembly portion 3 on the object-side surface S1 of the optical lens 10 (a surface parallel to the XY plane). It can be understood that, in some other embodiments, the protruding positioning units 4 may also be formed on the image-side surface S2 of the optical lens 10. When the protruding positioning units 4 are formed on the image-side surface S2, the reference surface is the surface of the assembly portion 3 on the image-side surface S2 (a surface parallel to the XY plane). Additionally, if different sets of protruding positioning units 4 are simultaneously formed on the object-side surface S1 and the image-side surface S2 of the optical lens 10, the different sets of protruding positioning units 4 have different reference surfaces. That is, for the protruding positioning units 4 formed on the object-side surface S1, the reference surface is the surface of the assembly portion 3 on the object-side surface S1. Conversely, for the protruding positioning units 4 formed on the image-side surface S2, the reference surface is the surface of the assembly portion 3 on the image-side surface S2. In the following paragraphs, for convenience of describing the features of this embodiment, the surface of the assembly portion 3 on the object-side surface S1 is defined as the reference surface.

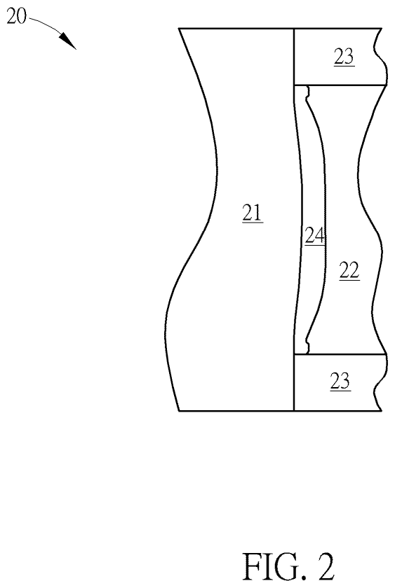

In the present invention, the protruding positioning units 4 formed on the reference surface not only enhance the alignment accuracy during the assembly of the optical lens 10 but also serve several other functions. One of these functions is to mitigate the impact of burrs caused by gaps between a sleeve and a movable mold core during the molding of the optical lens 10. More specifically, please refer to FIG. 2, which illustrates a cross-sectional schematic view of a mold for forming the optical lens. A mold 20 includes a fixed-side mold core 21, a movable-side mold core 22, and a sleeve 23. An inner contour shape of a gap 24 in the middle of the mold 20 is the same as an outer contour shape of the optical lens 10. In other words, lens material can be injected into the gap 24 of the mold 20 through injection molding or other methods to form the optical lens 10. However, since the movable-side mold core 22 is a movable component, it is more likely to form small gaps with the sleeve 23 during mold assembly. When the lens material is injected into the mold 20, the lens material may leak along these small gaps, and after the material solidifies, structures resembling burrs (i.e., small protruding portions) may form at the edges of the optical lens 10. These burrs are detrimental to the assembly steps of the optical lens 10, for example, causing dimensional errors during the assembly of the lens barrel and the optical lens 10 due to the presence of burrs. The protruding positioning units 4 formed in the present invention, due to their height (thickness in the optical axis direction) being much greater than that of the burr structures, ensure that during lens assembly, the lens barrel first contacts the protruding positioning units 4 without touching the burrs, thus reducing the impact of the burr structures on the assembly steps.

Another purpose of forming the protruding positioning units 4 in the present invention is to reduce thickness variations in the optical lens 10. During the formation of the optical lens 10 using a mold, process errors (e.g., filling pressure) may cause uneven thickness in the assembly portion of the optical lens 10. For example, the thickness difference between different sides of the optical lens 10 may be approximately 3 to 5 micrometers, and this thickness error also affects the lens assembly steps. The protruding positioning units 4 formed in the present invention protrude from the reference surface, and the thickness of the protruding positioning units 4 can compensate for, adjust, or reduce the thickness variations at each edge, improving assembly accuracy. Moreover, when the protruding positioning units 4 are symmetrically distributed on the optical lens, they help maintain flatness. At the same time, the height of the protruding positioning units 4 is not excessively high, which is beneficial for achieving consistent molding yield of the optical lens 10.

As described above, the concept of the present invention is to increase the telephoto magnification of the optical imaging lens by increasing the area of the optical portion 2 of the optical lens 10, while avoiding an excessive increase in the volume of the optical imaging lens. Therefore, the optical lens 10 is designed with a chamfered circular shape to save some volume. Additionally, a plurality of symmetrically and spaced-apart protruding positioning units 4 are designed on the assembly portion 3. The protruding positioning units 4 provide advantages such as improved assembly accuracy, reduced impact of burr structures, and reduced edge thickness variations of the optical lens.

In the following paragraphs, the detailed structure of the optical lens 10 of the present invention will be described. It should be understood that, although the following paragraphs may focus on describing the features of a single component, such as the structural features of one protruding positioning unit 4 or the parameters of one optical lens 10, these features or parameters may apply to all identical components included in the optical imaging lens (e.g., other protruding positioning units 4 or other optical lenses). Other components follow the same rule.

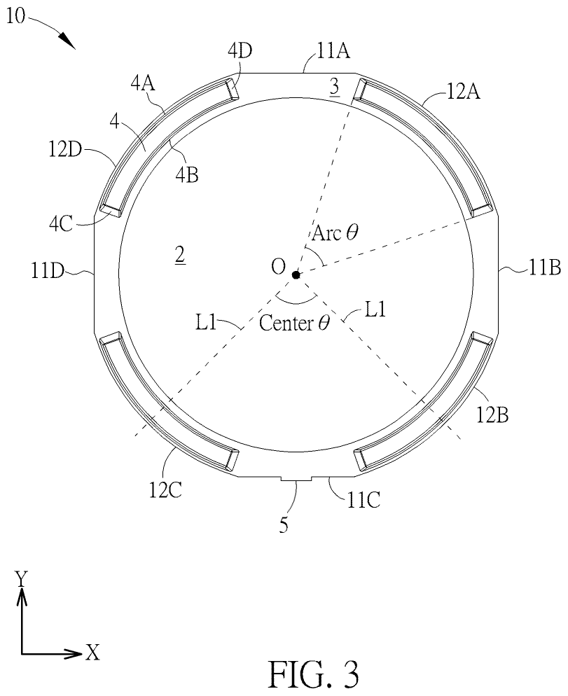

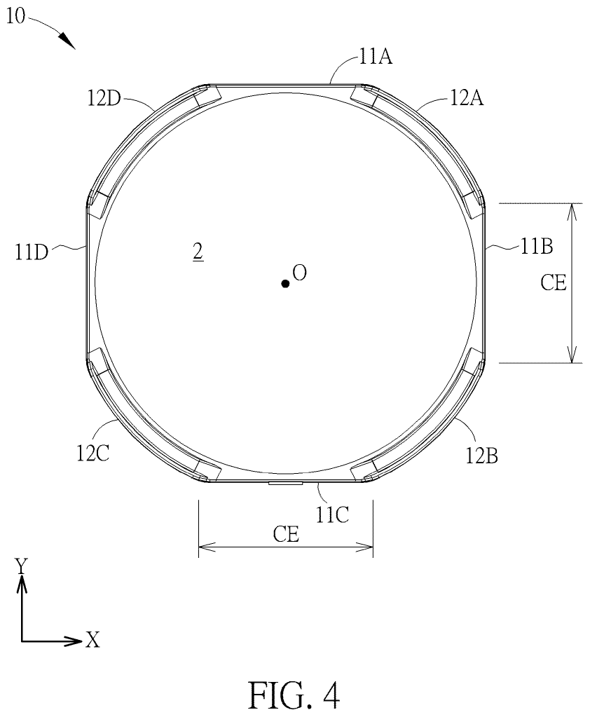

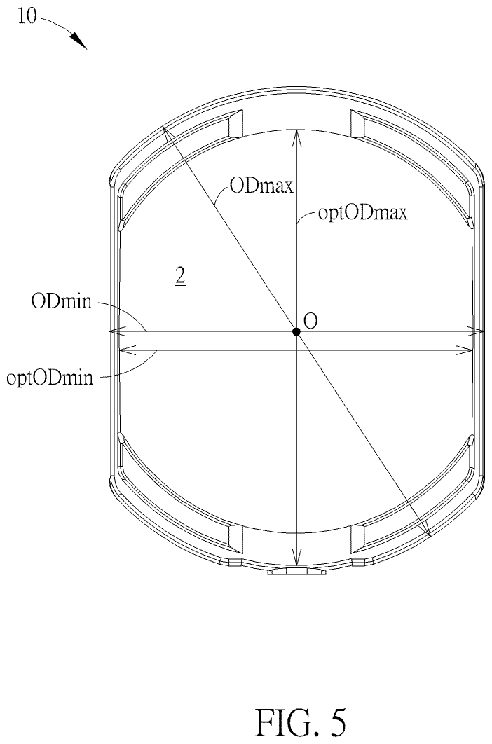

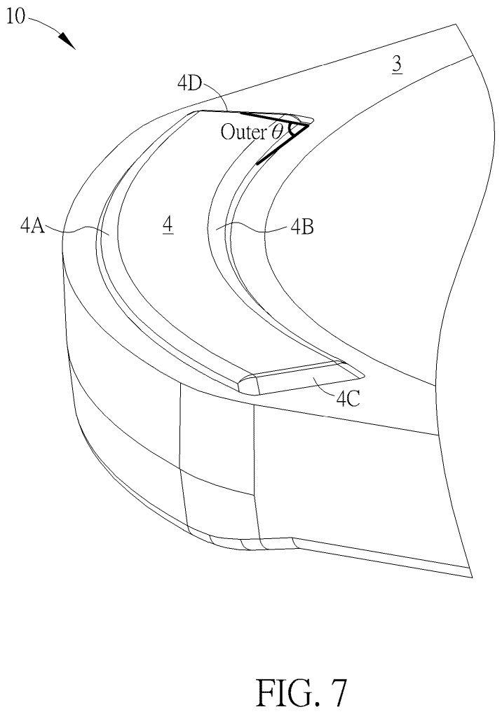

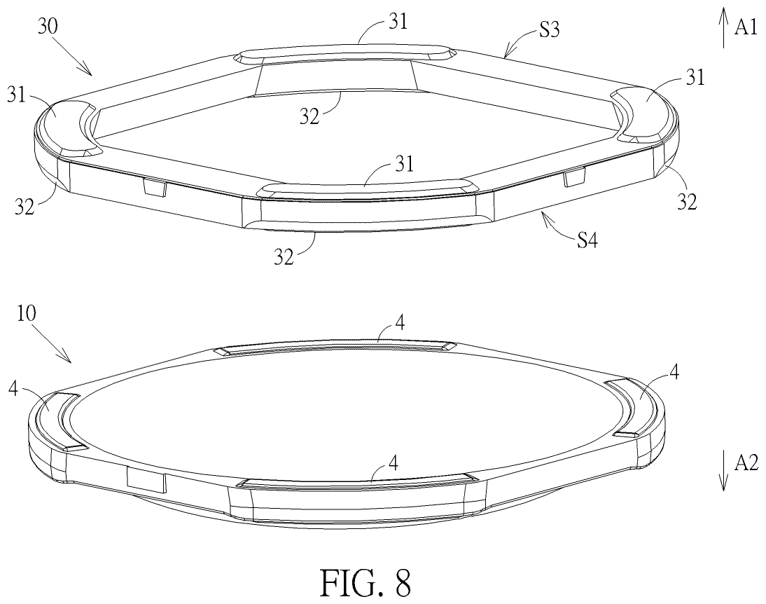

Please refer to FIG. 3, FIG. 4, FIG. 5, FIG. 6, FIG. 7, and FIG. 8. FIG. 3 illustrates a top view schematic diagram of an optical lens in an XY plane according to a first embodiment of the present invention. FIG. 4 illustrates a top view schematic diagram of an optical lens in an XY plane according to a second embodiment of the present invention. FIG. 5 illustrates a top view schematic diagram of an optical lens in an XY plane according to an eighth embodiment of the present invention. FIG. 6 illustrates a cross-sectional schematic view of a structure of an optical lens according to an embodiment of the present invention. FIG. 7 illustrates a partial enlarged perspective schematic view of the optical lens of the present invention. FIG. 8 illustrates a perspective schematic view of an optical lens and a spacer of the present invention.

It is worth noting that FIG. 3 to FIG. 5 respectively illustrate optical lenses of different embodiments. These optical lenses may be multiple optical lenses in a lens assembly of an optical imaging lens or may represent respective optical lenses in different optical imaging lenses, all of which fall within the scope of the present invention. The optical lenses shown in FIG. 3 to FIG. 5 slightly differ in area, size, shape, etc. For example, the assembly portion of the optical lens shown in FIG. 4 is narrower with longer chamfered edges, while the optical lens shown in FIG. 5 has only two chamfered edges, and the optical portion 2 is also non-circular. The above embodiments demonstrate that the optical lens of the present invention can be modified in shape, size, area, etc., according to requirements. As long as the optical lens satisfies the conditions described in the present invention, it falls within the scope of the present invention.

The following paragraphs first define the parameters mentioned in the present invention, please refer to FIG. 3 to FIG. 8 together. To clearly express the definitions of the parameters of the present invention, the lengths, angles, or positions represented by each parameter are marked in the figures, and for simplicity, the same parameters are not repeatedly marked in different embodiments. Those skilled in the art should be able to clearly understand the meaning of each parameter by comparing the embodiments.

Please refer to the top view in FIG. 3, each protruding positioning unit 4 includes two long sides and two short sides, wherein from the top view, the long sides are arc-shaped and extend along the edge of the assembly portion 3, while the short sides are straight lines and extend along the radial direction. FIG. 3 further marks the long sides 4A, 4B and short sides 4C, 4D of one of the protruding positioning units 4, wherein the long side 4A is farther from the optical axis (or a center point O), and the long side 4B is closer to the optical axis. Arcθ is an angle formed on the reference surface between lines connecting a center point O on the optical axis I to the two short sides 4C, 4D of any of the protruding positioning units 4. Additionally, a midpoint of the short sides and the center point O of the optical axis I are connected along the radial direction to form a virtual line L1, wherein an angle between any two adjacent virtual lines L1 is centerθ. Furthermore, in the present invention, N is defined as the number of the protruding positioning units 4, for example, in this embodiment, N=4, but the present invention is not limited thereto.

Please refer to FIG. 4, the optical lens 10 includes chamfered edges (i.e., the edges corresponding to the aforementioned vertical wall portions 11A, 11B, 11C, 11D), and a length of the chamfered edge in a first direction is defined as CE. It is worth noting that the first direction referred to here is the extension direction of the chamfered edge, meaning that in FIG. 4, some chamfered edges extend along the X-axis direction (e.g., 11A, 11C in FIG. 4), while others extend along the Y-axis direction (e.g., 11B, 11D in FIG. 4). Thus, the first direction may include the X-direction or the Y-direction.

Please refer to FIG. 5, the difference between this embodiment and the embodiments shown in FIG. 3 and FIG. 4 is that, in the previous embodiments, the optical portion 2 of the optical lens is circular, but in this embodiment, the optical portion 2 of the optical lens is not circular but a partially chamfered circular shape. In this embodiment, ODmin is a minimum diameter of the optical lens, ODmax is a maximum diameter of the optical lens, optODmin is a minimum diameter of the optical boundary of the optical lens, and optODmax is a maximum diameter of the optical boundary of the optical lens.

Please refer to the cross-sectional view in FIG. 6, which marks the positions of ArcOD, ArcID, ArcH, and TC. ArcOD represents an outer diameter of the protruding positioning units 4, ArcID is an inner diameter of the protruding positioning units 4, ArcH is a height of the protruding positioning units 4 relative to the reference surface, and TC is a thickness of the optical lens 10 along the optical axis I. Additionally, an acute angle formed between the long side 4B of the protruding positioning unit 4 closer to the optical axis and the optical axis direction (Z-axis) is defined as Innerθ.

Please refer to FIG. 7, which defines Outerθ as an acute angle formed between one of the short sides of the protruding positioning unit 4 and the reference surface. In other words, structurally, one of the short sides of the protruding positioning unit 4 forms a slanted surface, and the acute angle between this slanted surface and the XY plane (reference surface) is defined as Outerθ.

Please refer to FIG. 8, which illustrates the relationship between the optical lens 10 and a spacer 30, wherein the function of the spacer 30 is to fix the optical lens within the lens barrel, maintain spacing between optical lenses, and protect the periphery of the optical lenses. In this embodiment, in addition to the optical lens 10 itself having the protruding positioning units 4, the spacer 30 may also include a first surface S3 facing the first side A1 and a second surface S4 facing the second side A2, wherein the first surface S3 further includes at least one second protruding positioning unit 31, the second surface S4 further includes at least one third protruding positioning unit 32, and the third protruding positioning unit 32 abuts against the protruding positioning unit 4. In other words, the spacer 30 also includes protruding units, and the protruding units on the spacer 30 can contact the protruding positioning units 4 on the optical lens 10 to achieve positioning, lens protection, and other effects.

The definitions of the parameters included in the present invention have been introduced above. When these parameters satisfy the constraints described below, various corresponding advantages can be achieved. Details are provided in the following paragraphs.
1. The present invention provides an optical lens 10, the optical lens 10 having a first surface S1 facing a first side A1 and a second surface S2 facing a second side A2, an optical axis I passing through the optical lens 10, and a radial direction perpendicular to the optical axis being defined. The optical lens 10 further includes an optical portion 2 through which imaging rays can pass and an assembly portion 3 extending radially outward from an optical boundary, wherein the optical lens satisfies the condition: 4.8%≤(ODmin−optODmin)/ODmax×100%≤19.0%, where ODmin is a minimum diameter of the optical lens, ODmax is a maximum diameter of the optical lens, and optODmin is a minimum diameter of the optical boundary (i.e., when the optical portion 2 of the optical lens 10 is non-circular in a top view, the shortest distance between two endpoints on the boundary of the optical portion 2 passing through a center point of the optical portion 2; or when the optical portion 2 of the optical lens 10 is circular in a top view, the diameter of the circular optical portion 2). A gate cutting portion 5 is provided, and the assembly portion 3 closest to the gate cutting portion 5 is defined as a reference surface, wherein the assembly portion 3 further includes a plurality of protruding positioning units 4 protruding relative to the reference surface, the protruding positioning units being disposed on both sides of the gate cutting portion 5, each of the protruding positioning units 4 being symmetrically arranged and spaced apart, the protruding positioning units 4 not contacting each other, and each of the protruding positioning units 4 not contacting the gate cutting portion 5 (i.e., from a top view, the protruding positioning units 4 do not form a ring structure). The optical imaging lens satisfies the condition: 1.40≤(ODmax−optODmax)/(ArcOD−ArcID)≤1.80, where optODmax is a maximum diameter of the optical boundary (i.e., when the optical portion 2 of the optical lens 10 is non-circular in a top view, the longest distance between two endpoints on the boundary of the optical portion 2 passing through a center point of the optical portion 2; or when the optical portion 2 of the optical lens 10 is circular in a top view, the diameter of the circular optical portion 2, noting that when the optical portion 2 of the optical lens 10 is circular in a top view, optODmin=optODmax), ArcOD is an outer diameter of the protruding positioning units, and ArcID is an inner diameter of the protruding positioning units. The optical imaging lens further satisfies the condition: 0.95≤(π×ArcID×(Arcθ/360°))/(ArcOD−ArcID)≤6.00, wherein the protruding positioning units have two long sides 4A, 4B and two short sides 4C, 4D, the two long sides 4A, 4B being located between the two short sides 4C, 4D, wherein Arcθ is an angle formed on the reference surface between lines connecting a center point on the optical axis to the two short sides of any of the protruding positioning units.

As described above, the present invention designs an optical lens, and due to the radial size constraints of the assembly portion 3, particularly when satisfying the condition 4.8%≤(ODmin−optODmin)/ODmax×100%≤19.0%, i.e., when the proportion of the assembly portion 3 relative to the entire lens is small, a robust alignment structure for assembly with adjacent optical lenses is designed. When the condition (ODmin−optODmin)/ODmax×100%>4.8% is satisfied, the protruding positioning units are provided, and the protruding positioning units satisfy the condition 1.40≤(ODmax−optODmax)/(ArcOD−ArcID)≤1.80. On the assembly portion 3 with highly constrained dimensions, a structure capable of stable alignment and positioning is designed, facilitating the assembly of the lens itself and adjacent components, particularly solving assembly interference caused by burrs on the lens itself or adjacent components. By ensuring that the gate cutting portion 5 does not contact the protruding positioning units 4, and the arc segment length of each protruding positioning unit 4 satisfies 0.95≤(π×ArcID×(Arcθ/360°))/(ArcOD−ArcID)≤6.00, the swelling on the lens surface caused by the influence of molding filling pressure at the gate position is effectively addressed. This solves the issue of uneven flatness of the protruding positioning units 4 failing to meet flatness consistency standards, thereby effectively improving assembly yield and reducing flatness issues near the gate position. Furthermore, it facilitates improved flatness control and consistency in lens molding.
2. In some embodiments of the present invention, the protruding positioning units 4 are located on the first surface S1 of the optical lens 10. When the above condition is satisfied, it facilitates the assembly of the lens itself and adjacent components, particularly solving assembly interference caused by burrs on the lens itself or adjacent components.
3. In some embodiments of the present invention, one surface of the optical lens 10 preferably includes four protruding positioning units 4. When the condition that one surface of the optical lens 10 includes only four protruding positioning units 4 is satisfied, the overall shape of the optical lens 10 is more symmetrical, which is beneficial for improving assembly yield and ensuring stable surface shape during lens molding. In other embodiments, when the number of protruding positioning units is greater than four, more precise alignment is required, which may make assembly alignment between the lens and the lens barrel more difficult. If fewer than four protruding positioning units are used, the contact area between the optical lens 10 and other optical components may be insufficient, potentially leading to unstable assembly. However, the present invention does not limit one surface of the optical lens 10 to including only four protruding positioning units 4. Due to considerations of other process factors, an optical lens 10 with more or fewer than four protruding positioning units 4 may be designed, which also falls within the scope of the present invention.
4. In some embodiments of the present invention, the first side A1 or the second side A2 of the optical lens 10 has a spacer 30, the spacer 30 includes a first surface S3 facing the first side A1 and a second surface S4 facing the second side A2, the first surface S3 further includes a second protruding positioning unit 31, the second surface S4 further includes a third protruding positioning unit 32, and the third protruding positioning unit 32 abuts against the protruding positioning unit 4. When the above condition is satisfied, it facilitates avoiding interference from lens burrs and improving assembly flatness.
5. In some embodiments of the present invention, the assembly portion 3 further has a chamfered edge (corresponding to the vertical wall portions 11A, 11B, 11C, 11D) connecting the first surface S1 and the second surface S2, the chamfered edge contacts a lens barrel and is parallel to a first direction (e.g., X-axis or Y-axis direction), and the chamfered edge is a light-absorbing surface (e.g., the chamfered edge can be made into a light-absorbing surface using a coating method). When the above condition is satisfied, it facilitates reducing stray light in the lens.
6. In some embodiments of the present invention, the optical lens further satisfies the condition: 7.0%≤(ArcOD−ArcID)/ODmax×100%≤21.5%. When the above condition is satisfied, it facilitates designing an optimal ratio between the protruding positioning units 4 and the maximum outer diameter of the lens under radial size constraints of the assembly portion 3, avoiding interference from lens burrs and improving assembly flatness.
7. In some embodiments of the present invention, the optical lens further satisfies the condition: 0.75≤ArcID/ODmax≤0.91. When the above condition is satisfied, it facilitates designing an optimal ratio between the protruding positioning units 4 and the maximum outer diameter of the lens under radial size constraints of the assembly portion 3, avoiding interference from lens burrs and improving assembly flatness.
8. In some embodiments of the present invention, the optical lens further satisfies the condition: 0.50≤CE/(π×ArcOD×(Arcθ/360°))≤2.20, the assembly portion 3 further has a chamfered edge (11A, 11B, 11C, 11D) connecting the second surface S2 and the first surface S1, the chamfered edge contacts a lens barrel and is parallel to a first direction (X-direction or Y-direction), and CE is a length of the chamfered edge in the first direction. When the above condition is satisfied, it facilitates avoiding interference from lens burrs and improving assembly flatness.
9. In some embodiments of the present invention, a midpoint is defined between the two short sides 4C, 4D of each of the protruding positioning units 4, the midpoint of the short sides and a center point of the optical axis are connected along the radial direction to form a virtual line L1, wherein an angle between any two adjacent virtual lines is centerθ, satisfying the condition: 66°≤centerθ≤114°. When the above condition is satisfied, it facilitates even distribution of mutual contact pressure between optical lenses at the peripheral assembly portion, and symmetry is better with four or more protruding positioning units.
10. In some embodiments of the present invention, an acute angle formed between a long side of the protruding positioning unit closer to the optical axis and the optical axis direction is defined as Innerθ, an acute angle formed between one of the short sides of the protruding positioning unit and the reference surface is defined as Outerθ, and the condition 1.30≤Innerθ/Outerθ≤3.00 is satisfied. When the above condition is satisfied, it facilitates using the inner diameter of the protruding positioning unit as a feature circle for measuring lens eccentricity, making the projection of the eccentricity feature circle clearer. The angle ranges of Innerθ and Outerθ preferably satisfy 15°≤Innerθ≤45° and 15°≤Outerθ≤45°. When the above conditions are satisfied, it facilitates processing or reducing mold component processing costs and makes lens demolding easier. The optimal ratio of the two angles is 1.30≤Innerθ/Outerθ≤3.00.
11. In some embodiments of the present invention, the optical imaging lens satisfies the condition: 7.5%≤N×((ArcOD²−ArcID²)/ODmax²)×(Arcθ/360°)×100%≤13.0%, where N is the number of the protruding positioning units. When the above condition is satisfied, it facilitates designing the protruding positioning units, ensuring even distribution of mutual contact pressure between optical lenses at the peripheral assembly portion.
12. In some embodiments of the present invention, the optical lens further satisfies the condition: 2.5%≤ArcH/TC×100%≤5.1%, where ArcH is a height of the protruding positioning units relative to the reference surface, and TC is a thickness of the lens along the optical axis. When the above condition is satisfied, it facilitates avoiding burrs on the same side and burrs on adjacent optical lenses, improving assembly yield, and achieving better injection molding yield and surface shape, resulting in good imaging quality for the optical imaging lens.
13. In some embodiments of the present invention, the optical imaging lens satisfies the condition: 10%≤(ODmax−optODmax)/ODmax×100%≤32%. When the above condition is satisfied, it facilitates designing the protruding positioning units, ensuring even distribution of mutual contact pressure between optical lenses at the peripheral assembly portion.

The present invention further proposes some embodiments, as shown in Table 1 and Table 2 below, wherein 1^{st}-8^{th} embodiments represent the parameter values of different embodiments, with the definitions of each parameter as described above. The parameters of 1^{st}-8^{th} embodiments below satisfy the above condition ranges, so each embodiment can achieve the aforementioned advantages. It is worth noting that, although Table 1 and Table 2 list eight embodiments of the present invention, the embodiments shown are only a few examples of the present invention, and the present invention is not limited thereto.

TABLE 1

| | 1^{st} | 2^{nd} | 3^{rd} | 4^{th} |
|---|---|---|---|---|
| | embodiment | embodiment | embodiment | embodiment |
| ArcOD | 8.220 | 6.860 | 6.651 | 6.180 |
| ArcID | 7.330 | 5.814 | 5.200 | 5.136 |
| ArcH | 0.050 | 0.050 | 0.050 | 0.040 |
| Arcθ | 50.000 | 28.000 | 31.000 | 40.000 |
| ODmax | 8.330 | 7.080 | 6.880 | 6.580 |
| TC | 1.330 | 1.800 | 1.800 | 0.881 |
| CE | 2.307 | 3.581 | 3.205 | 2.567 |
| N | 4.000 | 4.000 | 4.000 | 4.000 |
| Innerθ | 45.00 | 45.00 | 45.00 | 45.00 |
| Outerθ | 15.00 | 15.00 | 15.00 | 15.00 |
| centerθ | 90.00 | 90.00 | 90.00 | 90.00 |
| optODmax | 7.027 | 5.247 | 4.700 | 4.884 |
| optODmin | 7.027 | 5.247 | 4.700 | 4.884 |
| ODmin | 8.000 | 6.000 | 6.000 | 6.000 |
| N × ((ArcOD² − ArcID²)/ODmax²) × | 11.1% | 8.2% | 12.5% | 12.1% |
| (Arcθ/360°) × 100% | | | | |
| ArcH/TC × 100% | 3.8% | 2.8% | 2.8% | 4.5% |
| (ArcOD − ArcID)/ODmax × 100% | 10.7% | 14.8% | 21.1% | 15.9% |
| ArcID/ODmax | 0.88 | 0.82 | 0.76 | 0.78 |
| CE/(π × ArcOD × (Arcθ/360°)) | 0.64 | 2.14 | 1.78 | 1.19 |
| (ODmax − optODmax)/ODmax × 100% | 15.6% | 25.9% | 31.7% | 25.8% |
| (ODmin − optODmin)/ODmax × 100% | 11.7% | 10.6% | 18.9% | 17.0% |
| (ODmax − optODmax)/(ArcOD − ArcID) | 1.46 | 1.75 | 1.50 | 1.62 |
| (π × ArcID × (Arcθ/360°))/ | 3.59 | 1.36 | 0.97 | 1.72 |
| (ArcOD − ArcID) | | | | |
| 1.30 ≤ Innerθ/Outerθ ≤ 3.00 | 3.00 | 3.00 | 3.00 | 3.00 |

TABLE 2

| | 5^{th} | 6^{th} | 7^{th} | 8^{th} |
|---|---|---|---|---|
| | embodiment | embodiment | embodiment | embodiment |
| ArcOD | 6.320 | 6.295 | 5.541 | 6.341 |
| ArcID | 5.763 | 5.828 | 4.800 | 5.600 |
| ArcH | 0.025 | 0.030 | 0.050 | 0.050 |
| Arcθ | 46.000 | 52.000 | 50.000 | 47.000 |
| ODmax | 6.460 | 6.460 | 6.000 | 6.800 |
| TC | 0.651 | 0.651 | 0.993 | 1.000 |
| CE | 2.149 | 2.079 | 3.009 | 4.002 |
| N | 4.000 | 4.000 | 4.000 | 4.000 |
| Innerθ | 45.00 | 20.00 | 45.00 | 45.00 |
| Outerθ | 15.00 | 15.00 | 15.00 | 15.00 |
| centerθ | 90.00 | 90.00 | 75.110 | 66.114 |
| optODmax | 5.528 | 5.675 | 4.800 | 5.600 |
| optODmin | 5.528 | 5.675 | 4.800 | 4.871 |
| ODmin | 6.000 | 6.000 | 5.191 | 5.200 |
| N × ((ArcOD² − ArcID²)/ODmax²) × | 8.2% | 7.8% | 11.8% | 10.0% |
| (Arcθ/360°) × 100% | | | | |
| ArcH/TC × 100% | 3.8% | 4.6% | 5.0% | 5.0% |
| (ArcOD − ArcID)/ODmax × 100% | 8.6% | 7.2% | 12.4% | 10.9% |
| ArcID/ODmax | 0.89 | 0.90 | 0.80 | 0.82 |
| CE/(π × ArcOD × (Arcθ/360°)) | 0.85 | 0.73 | 1.24 | 1.54 |
| (ODmax − optODmax)/ODmax × 100% | 14.4% | 12.2% | 20.0% | 17.6% |
| (ODmin − optODmin)/ODmax × 100% | 7.3% | 5.0% | 6.5% | 4.8% |
| (ODmax − optODmax)/(ArcOD − ArcID) | 1.68 | 1.68 | 1.62 | 1.62 |
| (π × ArcID × (Arcθ/360°))/ | 4.16 | 5.66 | 2.82 | 3.10 |
| (ArcOD − ArcID) | | | | |
| 1.30 ≤ Innerθ/Outerθ ≤ 3.00 | 3.00 | 1.33 | 3.00 | 3.00 |

The feature of the present invention lies in that, to increase the telephoto magnification of the optical imaging lens, it is necessary to increase the entrance pupil diameter of the optical imaging lens. However, since the entrance pupil diameter is proportional to the area of the first lens element of the optical imaging lens, this leads to an increase in the inner and outer diameter dimensions of the lens, resulting in an increased volume of the lens barrel, which is disadvantageous for the miniaturization of optical products. Therefore, the present invention improves the structure of the optical lens by chamfering the outer side of the optical lens in four different directions, transforming the originally cylinder-shaped sidewalls of the optical lens into a symmetrical and staggered arrangement of arc wall portions and vertical wall portions. This reduces the overall volume of the optical lens. Additionally, when forming the optical lens through injection molding, gaps may exist due to incomplete mold sealing, potentially causing burrs (small protruding structures) at the lens edges or uneven edge thickness due to process errors during material filling. To solve these issues, the assembly portion of the optical lens in this invention forms a plurality of protruding positioning units, the protruding positioning units being symmetrically arranged at intervals. The protruding positioning units help mitigate the effects of the aforementioned burrs and uneven edge thickness, improving the yield and quality of lens assembly.

The above description is only for the preferred embodiments of the present invention, and any equivalent changes and modifications made in accordance with the claims of the present invention should fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical lens, comprising the following features:
the optical lens has a first surface facing a first side and a second surface facing a second side;
an optical axis passes through the optical lens, and a radial direction perpendicular to the optical axis is defined;
the optical lens further includes an optical portion through which imaging rays can pass and an assembly portion extending radially outward from an optical boundary;
wherein the optical lens satisfies the condition: 4.8%≤(ODmin−optODmin)/ODmax×100%≤19.0%, wherein ODmin is a minimum diameter of the optical lens, ODmax is a maximum diameter of the optical lens, and optODmin is a minimum diameter of the optical boundary;
a gate cutting portion is provided, and the assembly portion closest to the gate cutting portion is defined as a reference surface;
wherein the assembly portion further includes a plurality of protruding positioning units protruding relative to the reference surface, the protruding positioning units being disposed on both sides of the gate cutting portion, each of the protruding positioning units being symmetrically arranged and spaced apart, the protruding positioning units not contacting each other, and each of the protruding positioning units not contacting the gate cutting portion;
wherein the optical imaging lens satisfies the condition: 1.40≤(ODmax−optODmax)/(ArcOD−ArcID)≤1.80, wherein optODmax is a maximum diameter of the optical boundary, ArcOD is an outer diameter of the protruding positioning units, and ArcID is an inner diameter of the protruding positioning units;
the optical imaging lens further satisfies the condition: 0.95≤(π×ArcID×(Arcθ/360°))/(ArcOD−ArcID)≤6.00, wherein the protruding positioning units have two long sides and two short sides, the two long sides being located between the two short sides, wherein Arcθ is an angle formed on the reference surface between lines connecting a center point on the optical axis to the two short sides of any of the protruding positioning units.

2. The optical lens according to claim 1, wherein the protruding positioning units are located on the first surface of the optical lens.

3. The optical lens according to claim 1, wherein the optical lens includes four of the protruding positioning units.

4. The optical lens according to claim 1, wherein the first side or the second side of the optical lens has a spacer, the spacer includes a first surface facing the first side and a second surface facing the second side, the first surface further includes a second protruding positioning unit, the second surface further includes a third protruding positioning unit, and the third protruding positioning unit abuts against the protruding positioning unit.

5. The optical lens according to claim 1, wherein the assembly portion further has a chamfered edge connecting the first surface and the second surface, the chamfered edge contacts a lens barrel and is parallel to a first direction, and the chamfered edge is a light-absorbing surface.

6. The optical lens according to claim 1, wherein the optical lens further satisfies the condition: 7.0%≤(ArcOD−ArcID)/ODmax×100%≤21.5%.

7. The optical lens according to claim 1, wherein the optical lens further satisfies the condition: 0.75≤ArcID/ODmax≤0.91.

8. The optical lens according to claim 1, wherein the optical lens further satisfies the condition: 0.50≤CE/(π×ArcOD×(Arcθ/360°))≤2.20, the assembly portion further has a chamfered edge connecting the second surface and the first surface, the chamfered edge contacts a lens barrel and is parallel to a first direction, and CE is a length of the chamfered edge in the first direction.

9. The optical lens according to claim 1, wherein a midpoint is defined between the two short sides of each of the protruding positioning units, the midpoint of the short sides and a center point of the optical axis are connected along the radial direction to form a virtual line, wherein an angle between any two adjacent virtual lines is centerθ, satisfying the condition: 66°≤centerθ≤114°.

10. The optical lens according to claim 1, wherein an acute angle formed between a long side of the protruding positioning unit closer to the optical axis and the optical axis direction is defined as Innerθ, an acute angle formed between one of the short sides of the protruding positioning unit and the reference surface is defined as Outerθ, and the condition 1.30≤Innerθ/Outerθ≤3.00 is satisfied.

11. The optical lens according to claim 1, wherein the optical imaging lens satisfies the condition: 7.5%≤N×((ArcOD²−ArcID²)/ODmax²)×(Arcθ/360°)×100%≤13.0%, where N is the number of the protruding positioning units.

12. The optical lens according to claim 1, wherein the optical lens further satisfies the condition: 2.5%≤ArcH/TC×100%≤5.1%, wherein ArcH is a height of the protruding positioning units relative to the reference surface, and TC is a thickness of the lens along the optical axis.

13. The optical lens according to claim 1, wherein the optical imaging lens satisfies the condition: 10%≤(ODmax−optODmax)/ODmax×100%≤32%.
